(19) United States
(12) Patent Application Publication
(10) Pub. No.: US 2019/0226539 A1
(43) Pub. Date: Jul. 25, 2019

(54) PAD LINER FOR BRAKING APPARATUS

(71) Applicant: HYUNDAI MOBIS CO., LTD., Seoul (KR)

(72) Inventors: Hyeong Sik KIM, Yongin-si (KR); Sang Bum KIM, Suncheon-si (KR); Choong Sik SHIN, Suwon-si (KR)

(21) Appl. No.: 16/206,261

(22) Filed: Nov. 30, 2018

(30) Foreign Application Priority Data
Jan. 23, 2018 (KR) 10-2018-0008511

(51) Int. Cl. F16D 65/097

(52) U.S. Cl. CPC F16D 65/0978; F16D 55/225

(57) ABSTRACT

A pad liner for a brake apparatus includes a pair of main body parts that are in contact with a torque member and are arranged to be spaced apart from each other, insertion parts, each insertion part connected to the main body part and a torque member protrusion of the torque member being inserted thereinto, guide parts, each guide portion extending from the insertion parts to one side, contacting the brake pad and guiding movement of the brake pad, supporting parts, each supporting part extending from the guide part in the same direction as the insertion part and supporting the brake pad, and return parts, each return part extending from an upper end of the body part toward the guide part and providing an elastic restoring force to the brake pad.

### CROSS-REFERENCES TO RELATED APPLICATIONS

The present application claims priority to Korean application number 10-2018-0008511, filed on Jan. 23, 2018, which is incorporated by reference in its entirety.

### BACKGROUND OF THE INVENTION

The present invention relates to a pad liner for a braking apparatus, and more particularly, to a pad liner for a braking apparatus, which can be used in common for brake calipers of various specifications, and in which a coupling force with a torque member is increased as well as a brake pad can be restored to its original state.

Generally, a caliper of a braking apparatus for braking is a device which is brought into close contact with a brake disc when a pedal is depressed and consists of a plurality of parts.

Among the plurality of parts, pad liners are made to new specifications according to the size and thickness of the brake disc. Accordingly, there is a problem in that it is difficult to manage the derivative specification because the cost of manufacturing the mold required for production of the pad liners is continuously generated and it is difficult to share parts with each other. Therefore, there is a need to improve this.

### SUMMARY OF THE INVENTION

Embodiments of the present invention are directed to a pad liner for a braking apparatus, which can be used in common for brake calipers of various specifications, and in which a coupling force with a torque member is increased as well as a brake pad can be restored to its original state.

The pad liner for a braking apparatus according an aspect of the present invention may include: a pair of main body parts that are in contact with a torque member and are arranged to be spaced apart from each other; insertion parts, each insertion part connected to the main body part and a torque member protrusion of the torque member being inserted thereinto; guide parts, each guide portion extending from the insertion parts to one side, contacting the brake pad and guiding movement of the brake pad; supporting parts, each supporting part extending from the guide part in the same direction as the insertion part and supporting the brake pad; and return parts, each return part extending from an upper end of the main body part toward the guide part and providing an elastic restoring force to the brake pad.

Each of the return parts may include a return plate portion extending forward from the upper end of the main body part; and a return slope portion extending obliquely in the direction of the guide portion at opposite sides of the return plate.

The return part further may include a return notifying portion bent from an end portion of the return slope portion toward the supporting part to contact a brake disc when the brake pad is worn.

Each of the insertion parts may include a first insertion plate portion bent at an end portion of the main body part in a forward direction of the main body part; a second insertion plate portion bent at an end portion of the first insertion plate portion so as to bend toward the guide part; and a third insertion plate portion bent extending to be bent from an end portion of the second insertion plate portion to the rear side of the second insertion plate portion to face the first insertion plate portion and connected to the guide part.

The insertion part may further include a stopper portion extending to be bent from one side of the second insertion plate portion to the torque member side and coming into close contact with the torque member.

The stopper portion may include a first stopper portion made of an elastic material and extending to be bent from an opposite side of the opposite side portions of the second insertion plate portion toward the torque member side; and a second stopper portion extending to be bent from an end portion of the first stopper portion to the outside of the torque member and coming into close contact with the torque member.

The insertion part may further include an insertion pressing portion formed on the first insertion plate part and brought into close contact with the inserted torque member.

The insertion pressing portion may include a pressing hole portion formed from the main body part to the first insertion plate portion; a pressing contact portion extending from the main body part and positioned in the pressing hole portion; and a pressing slope portion extending from an end portion of the pressing contact portion to the third insertion plate portion.

Each of the guide parts may include a guide plate portion extending from the third insertion plate portion to one side and connected to the supporting part; and a first guide stopper portion formed on the guide plate portion and protruding to a front side of the guide plate portion to restrict release of the brake pad.

The guide part further may include a second guide stopper portion extending to be bent to the torque member side from the opposite sides of the guide plate portion and brought into close contact with the torque member.

### BRIEF DESCRIPTION OF THE DRAWINGS

FIG. 1 is a perspective view schematically illustrating a braking apparatus according to an embodiment of the present invention.

FIG. 2 is an enlarged view of a portion in which a pad liner for a braking apparatus is engaged with a torque member in an embodiment of the present invention.

FIG. 3 is a cross-sectional view taken along the line A-A′ of FIG. 2.

FIG. 4 is a perspective view schematically illustrating pad liners for a braking apparatus according to an embodiment of the present invention.

FIG. 5 is a front view of pad liners for a braking apparatus according to an embodiment of the present invention.

FIG. 6 is a side view of pad liners for a braking apparatus according to an embodiment of the present invention.

FIG. 7 is a view illustrating a brake pad which is moved according to the operation of a cylinder of a braking apparatus according to an embodiment of the present invention.

FIG. 8 is a view illustrating that a brake pad is restored to its original position by the deactivation of a cylinder of a braking apparatus according to an embodiment of the present invention.

FIG. 9 is a view illustrating that the return portions of pad liners for a braking apparatus according to an embodiment of the present invention reports the wear state of a brake pad.

FIGS. 10 and 11 are views illustrating that pad liners for a braking apparatus are applicable to various specifications of a brake caliper according to an embodiment of the present invention.

### DESCRIPTION OF SPECIFIC EMBODIMENTS

Hereafter, a pad liner for a braking apparatus in accordance with an embodiment of the present invention will be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

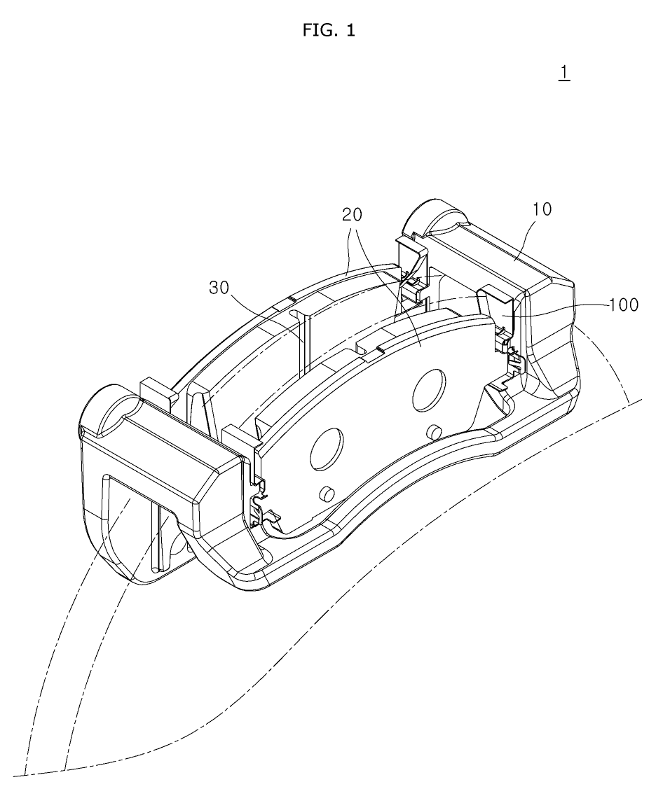

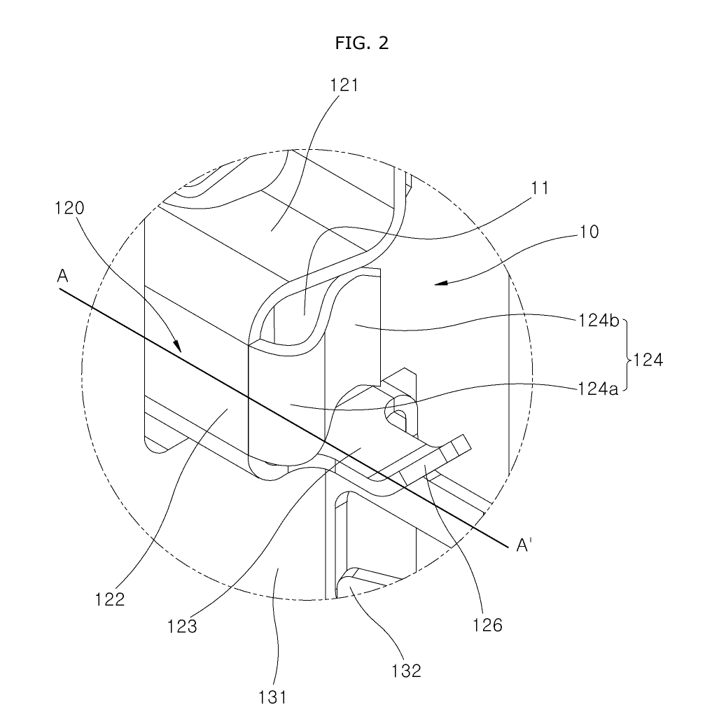

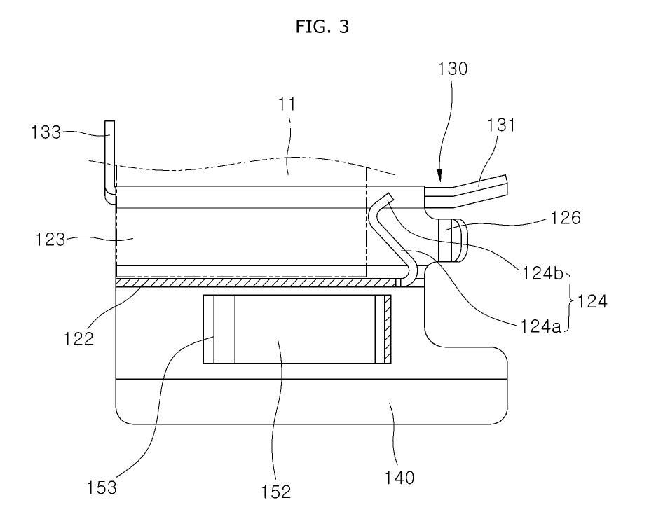

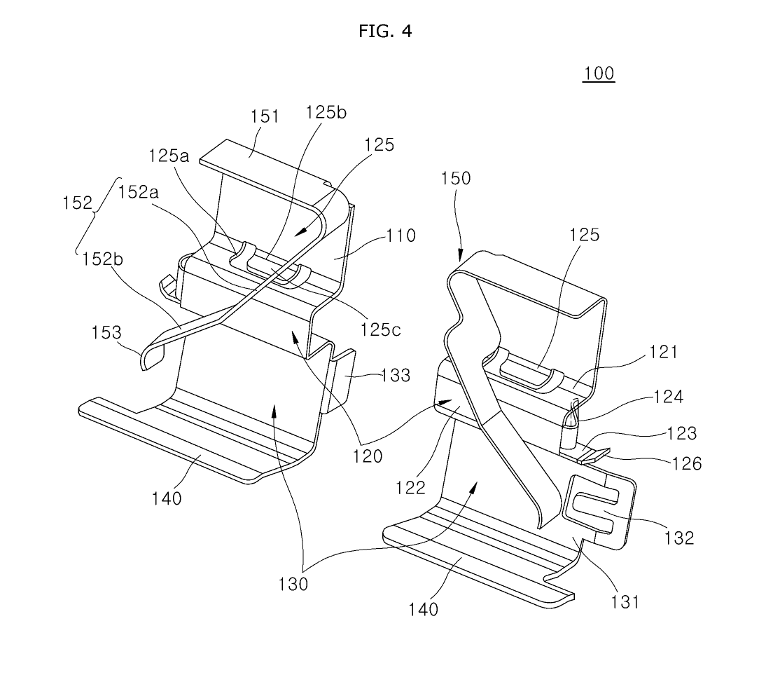

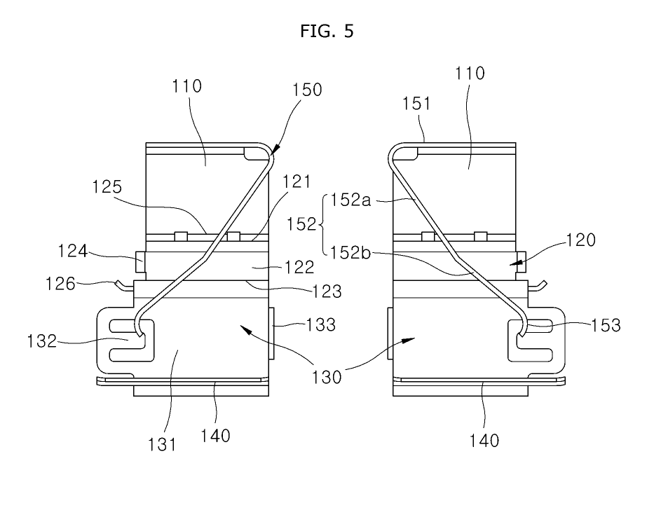

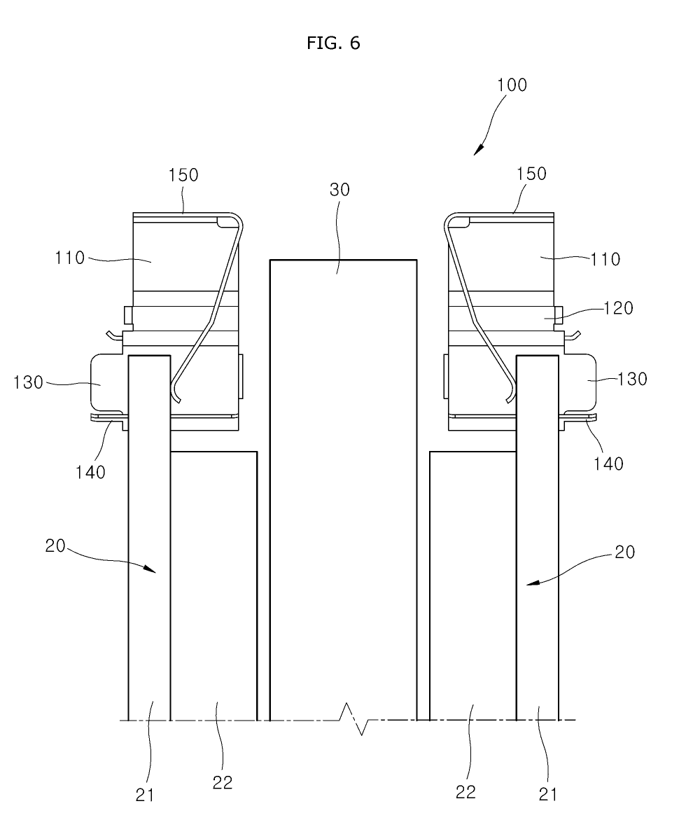

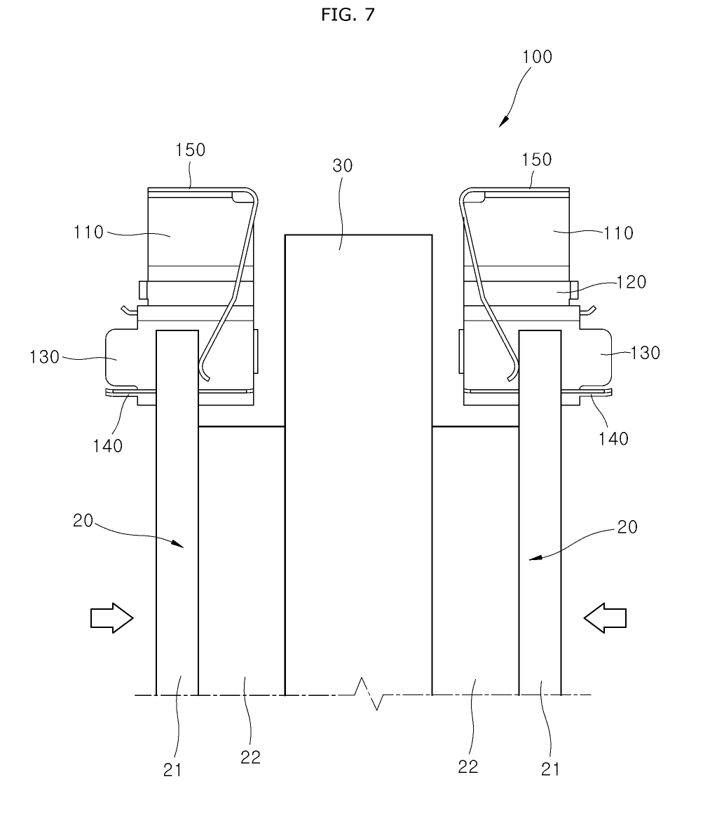

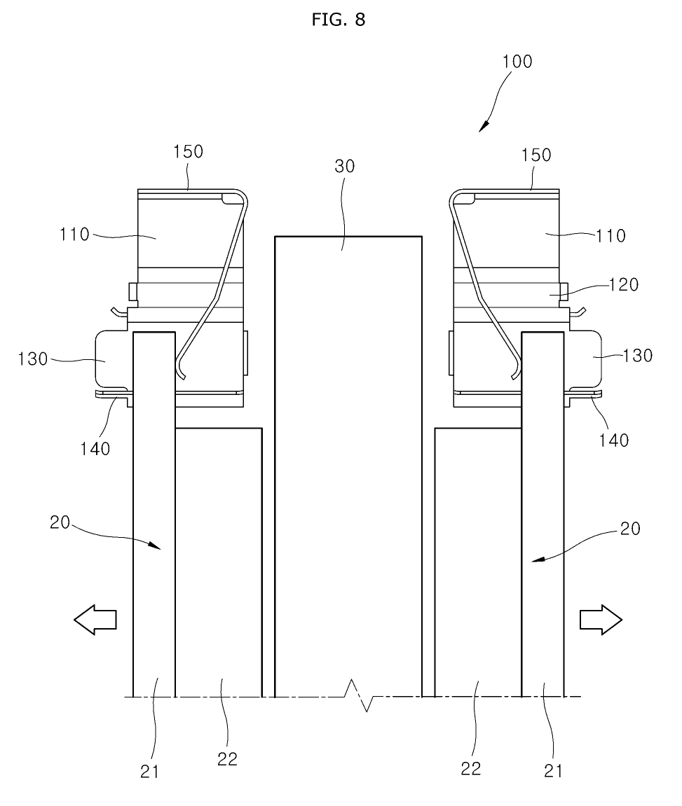

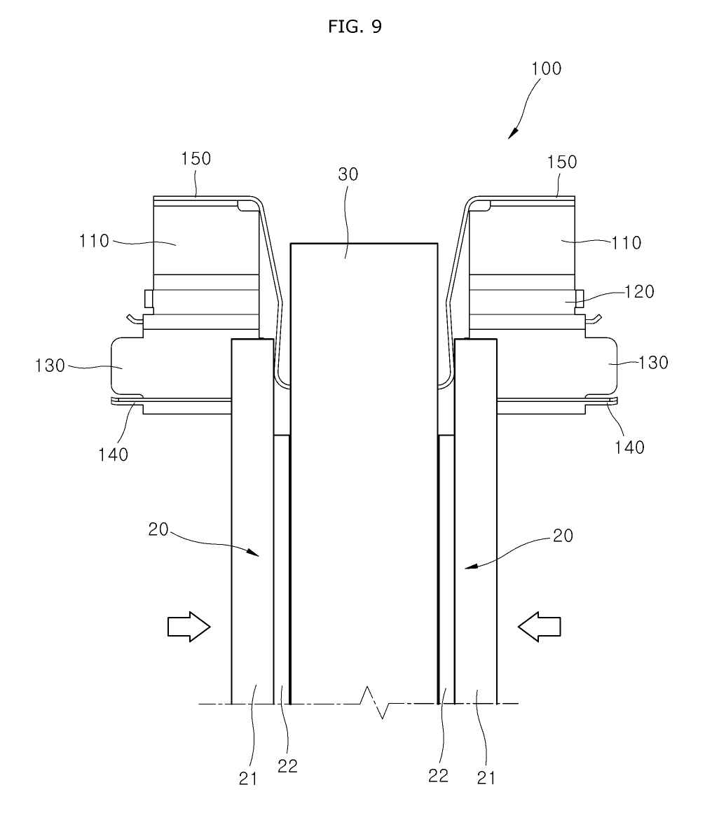

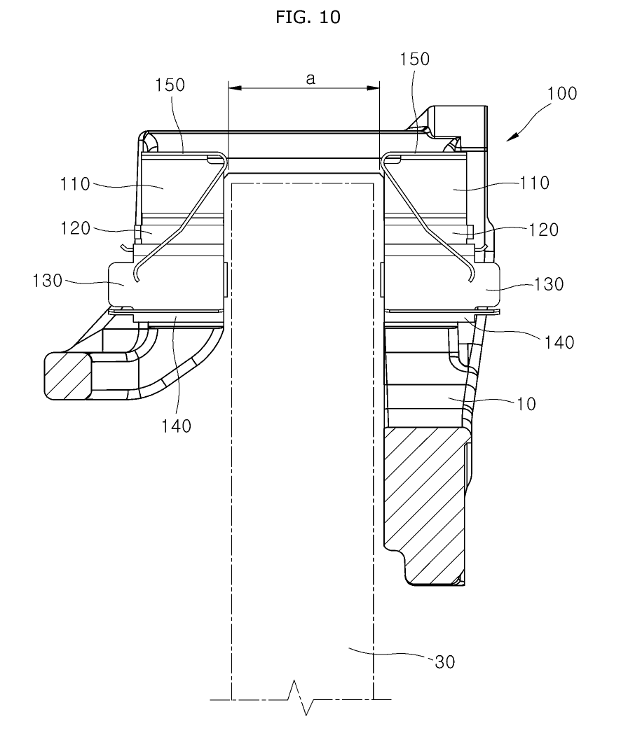

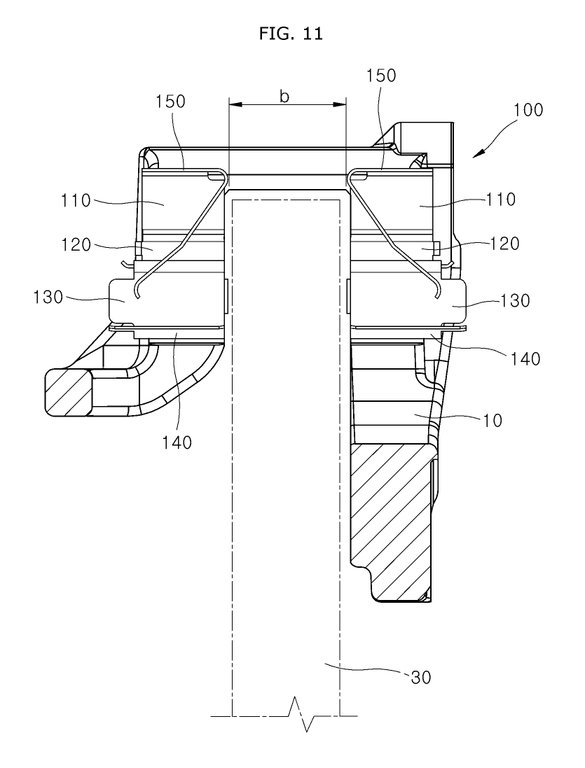

FIG. 1 is a perspective view schematically illustrating a braking apparatus according to an embodiment of the present invention, FIG. 2 is an enlarged view of a portion in which a pad liner for a braking apparatus is engaged with a torque member in an embodiment of the present invention, FIG. 3 is a cross-sectional view taken along the line A-A′ of FIG. 2, FIG. 4 is a perspective view schematically illustrating pad liners for a braking apparatus according to an embodiment of the present invention, FIG. 5 is a front view of the pad liners for a braking apparatus according to an embodiment of the present invention, FIG. 6 is a side view of the pad liners for a braking apparatus according to an embodiment of the present invention, FIG. 7 is a view illustrating the brake pad which is moved according to the operation of a cylinder of a braking apparatus according to an embodiment of the present invention, FIG. 8 is a view illustrating that the brake pad is restored to its original position by the deactivation of the cylinder of the braking apparatus according to an embodiment of the present invention, FIG. 9 is a view illustrating that the return portions of the pad liners for a braking apparatus according to an embodiment of the present invention reports the wear state of the brake pad, and FIGS. 10 and 11 are views illustrating that the pad liners for a braking apparatus are applicable to various specifications of a brake caliper according to an embodiment of the present invention.

Referring to FIGS. 1 to 6, the pad liner 100 for a brake apparatus according to an embodiment pf the present invention may include a pair of main body parts 110, a pair of insertion parts 120, a pair of guide parts 130, a pair of support part 140 and a pair of return parts 150. The pad liner 100 for a brake apparatus may include a metal material and may be integrally formed.

The pair of main body parts 110 may contact a torque member 10 in a plate shape and may be arranged to be spaced apart from each other. The main body parts 110 can be brought into close contact with a torque member 10 by being fitted to a torque member protrusion 11 of the torque member 10.

Each of the insertion parts 120 may be connected to the main body parts 110, respectively and the torque member protrusion 11 of the torque member 10 may be inserted. Specifically, the torque member protrusion 11 of the torque member 10 may be inserted into the insertion part 120 in a ‘C’ shape (see FIG. 2). That is, the torque member protrusion 11 of the torque member 10 may be fitted to the insertion part 120.

Each of the guide parts 130 may extend from the insertion part 120 to one side and contact a brake pad 20 to guide the movement of the brake pad 20. Specifically, each of the brake pad 20 may include a pad supporting part 21 and a pad friction part 22. The pad supporting part 21 may include a pad supporting part body (not shown) and a pad protrusion part (not shown). The pad supporting part body can be moved in combination with a cylinder. The pad protrusion part may extend from both side ends of the pad supporting part body and be inserted into the guide part 130. The pad friction part 22 may be attached to the pad supporting part 21 and may contact a brake disc 30 to provide friction.

Each of the supporting parts 140 may extend to be bent from the guide part 130 in the same direction as the insertion part 120 and support the brake pad 20. Each of the supporting parts 140 may extend to be bent from the lower end of the guide part 130 (based on FIG. 4) toward the brake pad 20 side to support the brake pad 20 when the brake pad 20 is moved.

Each of the return parts 150 may extend from an upper end of the main body part 110 in a direction of the guide part 130 and provide an elastic restoring force to the brake pad 20. The return parts 150 may extend downward (based on FIGS. 4 and 5) from the upper ends of the main body parts 110 in a pair. Each of the return parts 150 may be formed of an elastic material and be disposed between the brake pads 20 so that the return parts 150 may guide the brake pads 20 to be separated from the brake disc 30 by an elastic restoring force when an external force against the brake pads 20, which is provided by the cylinder 40, is removed.

Each of the return parts 150 may include a return plate portion 151 and a return slope portion 152. The return plate portion 151 may extend forward from the upper end of the main body part 110. The return slope portion 152 may extend obliquely toward the guide part 130 from the return plate portion 151. As shown in FIG. 4, the return slope portion 152 may include a first return slope portion 152a and a second return slope portion 152b. The first return slope portion 152a may extend obliquely at a predetermined angle toward the guide part 130 from the return plate portion 151. The second return slope portion 152b may extend obliquely at a predetermined angle toward the guide part 130 from an end portion of the first return slope portion 152a.

Each of the return part 150 may further include a return notifying portion 153. The return notifying portion 153 may be formed to be bent toward the supporting part 140 at an end portion of the return slope portion 152. That is, the return notifying portion 153 may be formed to be bent from the end portion of the return slope portion 152 downward (based on FIGS. 4 and 5). The return notifying portion 153 may notify the driver of the replacement timing of the brake pad 20 by contacting the brake disc 30 to generate noise when the pad friction part 22 is worn out (see FIG. 9). As a result, the driver can recognize the replacement timing of the brake pad 20. In addition, the return notifying portion 153 may have a bent shape toward the support part 140, whereby reducing the resistance when the return slope portion 152 is restored to the original position by the elastic restoring force.

Each of the insertion part 120 may include a first insertion plate portion 121, a second insertion plate portion 122 and a third insertion plate portion 123. The first insertion plate portion 121 may extend to be bent forward of the main body part 110 at the end portion of the main body part 110. The second insertion plate portion 122 may extend to be bent from the first insertion plate portion 121 in the direction of the guide part 130. The third insertion plate portion 123 may extend to be bent from an end portion of the second insertion plate portion 122 to the rear side of the second insertion plate portion 122. The third insertion plate portion 123 may face the first insertion plate portion 121 and be connected to the guide part 130. The torque member protrusion 11 protruding from the torque member 10 may be inserted into the space formed through the first insertion plate portion 121, the second insertion plate portion 122 and the third insertion plate portion 123.

As described above, the pad liners 100 for a braking apparatus are formed to be fitted to the torque member protrusion 11 of the torque member 10 as a pair, so that the pad liners 100 can be applied to the torque member 10, that is, the pad liners 100 can be applied to the brake caliper 1 of various specifications even if the size and the thickness of the brake disc 20 are changed. For example, even when the thickness of the brake disc 20 varies from a to b, and the specification of the torque member 10 changes, the pad liners 100 for a brake apparatus of the present invention can be applied (see FIGS. 10 and 11). That is, the pad liners 100 for a brake apparatus can be used in common, so that it can be mounted on the torque member 10 of various specifications.

Each of the insertion parts 120 may further include a stopper portion 124. The stopper portion 124 may extend from one side of the second insertion plate portion 122 toward the torque member 10 side and be in close contact with the torque member 10. Specifically, the stopper portion 124 may be brought into close contact with the torque member 10 inserted into the insertion part 120 by an elastic restoring force to increase the coupling force between the torque member 10 and the pad liners 100 for a braking apparatus. As a result, even if the return part 150 is restored to its original state by the elastic restoring force, the horizontal movement of the pad liners 100 for a braking apparatus may be restricted, so that the pad liners 100 for a braking apparatus can be prevented from being deviated to the outside.

The stopper portion 124 may include a first stopper portion 124a and a second stopper portion 124b. The first stopper portion 124a may be formed of an elastic material and be bent at a predetermined angle toward the torque member 10 side at the opposite side of the opposite sides of the second insertion plate portion 122 (see FIGS. 4 and 5).

The second stopper portion 124b may extend to be bent outwardly of the torque member 10 at an end portion of the first stopper portion 124a and be in close contact with the torque member 10. As such, since the second stopper portion 124b extend to be bent outwardly of the torque member 10 at the end portion of the first stopper portion 124a, it is possible to reduce the breakage of the torque member 10 due to the stopper portion 124 when the stopper portion 124 is in close contact with the torque member 10.

Each of the insertion parts 120 may further include an insertion pressing portion 125. The insertion pressing portion 125 may be formed in the first insertion plate portion 121 and be in close contact with the torque member 10 to be inserted. The insertion pressing portion 125 may be brought into close contact with the inserted torque member protrusion 11 to increase the coupling force between the torque member 10 and the pad liner 100 for a braking apparatus.

The insertion pressing portion 125 may include a pressing hole portion 125a, a pressing contact portion 125b, and a pressing slope portion 125c. The pressing hole portion 125a may be formed from the main body part 110 to the first insertion plate portion 121. The pressing contact portion 125b may extend from the main body part 110 and be located in the pressing hole portion 125a. The pressing slope portion 125c may extend toward the third insertion plate portion 123 side from the lower end portion (based on FIG. 4) of the pressing contact portion 125b. The pressing slope portion 125c may be made of an elastic material and press the torque member protrusion 11 inserted into the insertion part 120 by an elastic restoring force. Specifically, the torque slope portion 125c may elastically deform while the torque member protrusion 11 is inserted into the insertion part 120. However, when the torque member protrusion 11 is inserted into the insertion part 120, the torque member protrusion 11 may be restored to its original state by an elastic restoring force and be brought into close contact with and press the torque member protrusion 11. As a result, the coupling force between the insertion part 120 and the torque member protrusion 11 can be increased.

Each of the insertion parts 120 may further include an insertion guide portion 126. The insertion guide portion 126 may extend from the side of the third insertion plate portion 123 and protrude to have a slope toward the first insertion plate portion 121, that is upwardly (based on FIGS. 4 and 5). As a result, when assembling the brake pad 20 to the guide part 130, the brake pad 20 can be easily guided and assembled to the guide part 130. Further, when the torque member protrusion 11 is inserted into the insertion part 120, the horizontal movement of the torque member protrusion 11 may be restricted.

The guide part 130 may include a guide plate portion 131 and a first guide stopper portion 132. The guide plate portion 131 may extend from the third insertion plate portion 123 to one side and be connected to the supporting part 140. The guide plate portion 131 may extend downward (based on FIG. 4) from the end portion of the third insertion plate portion 123 to contact the torque member 10.

The first guide stopper portion 132 may be formed on the guide plate portion 131 and protrude forward of the guide plate portion 131 to restrict the release of the brake pad 20. The first guide stopper portion 132 may be formed on both sides of the guide plate portion 131 by hole machining and protrude forward of the guide plate portion 131. As a result, a pad protrusion of the pad supporting part 21 disposed close to the guide plate portion 131 may be caught and restricted from moving by the first guide stopper portion 132 and be prevented from being detached to the outside of the guide plate portion 131.

Each of the guide parts 130 may further include a second guide stopper portion 133. The second guide stopper portion 133 may extend to be bent toward the torque member 10 from the opposite sides of the guide plate portion 131 and be in close contact with the torque member 10. As a result, it is possible to restrict the horizontal movement of the pad liners 100 for a braking apparatus through the second guide stopper portion 133 when the pad liners 100 for a braking apparatus are engaged with the torque member 10.

In the braking apparatus 1 according to the present invention, the same structure is provided on the opposite side of the torque member 10 provided with the pad liners 100 for the brake apparatus. Since the operation and effect of the configuration are also the same, a detailed description will be omitted.

Hereinafter, the operations and effects of the braking apparatus according to an embodiment of the present invention will be described in detail with reference to FIGS. 6 to 9.

The torque member protrusion 11 formed on the torque member 10 is inserted into the insertion part 120. At this time, the stopper portion 124 and the insertion pressing portion 125 are elastically deformed by the torque member protrusion 11 inserted into the insertion part 120, and when the torque member protrusion 11 is inserted into the insertion part 120, the stopper portion 124 and the insertion pressing portion 125 are brought into close contact with and press the torque member protrusion 11 while being restored to its original state by the elastic restoring force.

When the torque member 10 and the insertion part 120 are engaged, the brake pads 20 are mounted. The pad protruding portion of the pad supporting parts 21 are moved along the guide part 130 by the operation of a piston 40. At this time, the return slope portion 152 of the return part 150 elastically supports the edge of the pad supporting part 21.

When a driver operates a brake pedal (not shown), hydraulic pressure is transmitted to the torque member 10. The hydraulic pressure causes the piston 40 to press the brake pads 20 toward the brake disc 30 (see FIG. 7). As such, the brake pads 20 are brought into close contact with the brake disc 30 and rubbed to generate a braking force. At this time, the return part 150 is in a state elastically deformed by the pressure of the brake pads 20.

On the other hand, when the driver does not operate the brake pedal during the brake release, the hydraulic pressure does not act on the piston 40 and the elastic restoring force of the return part 150 restores the brake pads 20 so that the brake pads 20 are sufficiently separated from the brake disc 30. The brake pads 20 are separated to the left and right sides of the brake disc 30 (based on FIG. 8) by the return part 150. At this time, since the stopper portion 124 is in close contact with the torque member 10 inserted into the insertion part 120 by the elastic restoring force, even if the brake pads 20 are restored to the original state by the elastic restoring force of the return part 150, the pad liner 100 for a braking apparatus can be prevented from deviating to the outside. In addition, the brake pads 20 are sufficiently spaced from the brake disc 30, thereby preventing the drag phenomenon due to the contact friction between the brake pads 20 and the brake disc 30.

When a pad friction portion 22 is worn out by the use of the brake for a long time, the return notifying portion 153 contacts the brake disc 30 to cause noise when the brake pad 20 is moved in the direction of the brake disc 30 (see FIG. 9). As a result, the driver can recognize the replacement timing of the brake pads 20 and can quickly replace them.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A pad liner for a braking apparatus, comprising:
a pair of main body parts that are in contact with a torque member and are arranged to be spaced apart from each other;
insertion parts, each insertion part connected to the main body part and a torque member protrusion of the torque member being inserted thereinto;
guide parts, each guide portion extending from the insertion parts to one side, contacting the brake pad and guiding movement of the brake pad;
supporting parts, each supporting part extending from the guide part in the same direction as the insertion part and supporting the brake pad; and
return parts, each return part extending from an upper end of the main body part toward the guide part and providing an elastic restoring force to the brake pad.

2. The pad liner for a braking apparatus of claim 1, wherein each of the return parts comprises:
a return plate portion extending forward from the upper end of the main body part; and
a return slope portion extending obliquely in the direction of the guide portion at opposite sides of the return plate.

3. The pad liner for a braking apparatus of claim 2, wherein the return part further comprises a return notifying portion bent from an end portion of the return slope portion toward the supporting part to contact a brake disc when the brake pad is worn.

4. The pad liner for a braking apparatus of claim 1, wherein each of the insertion parts comprises:
a first insertion plate portion bent at an end portion of the main body part in a forward direction of the main body part;
a second insertion plate portion bent at an end portion of the first insertion plate portion so as to bend toward the guide part; and
a third insertion plate portion bent extending to be bent from an end portion of the second insertion plate portion to the rear side of the second insertion plate portion to face the first insertion plate portion and connected to the guide part.

5. The pad liner for a braking apparatus of claim 4, wherein the insertion part further comprises a stopper portion extending to be bent from one side of the second insertion plate portion to the torque member side and coming into close contact with the torque member.

6. The pad liner for a braking apparatus of claim 5, wherein the stopper portion comprises:
a first stopper portion made of an elastic material and extending to be bent from an opposite side of the opposite side portions of the second insertion plate portion toward the torque member side; and
a second stopper portion extending to be bent from an end portion of the first stopper portion to the outside of the torque member and coming into close contact with the torque member.

7. The pad liner for a braking apparatus of claim 4, wherein the insertion part further comprises an insertion pressing portion formed on the first insertion plate part and brought into close contact with the inserted torque member.

8. The pad liner for a braking apparatus of claim 7, wherein the insertion pressing portion comprises:
a pressing hole portion formed from the main body part to the first insertion plate portion;
a pressing contact portion extending from the main body part and positioned in the pressing hole portion; and
a pressing slope portion extending from an end portion of the pressing contact portion to the third insertion plate portion.

9. The pad liner for a braking apparatus of claim 4, wherein each of the guide parts comprises:
a guide plate portion extending from the third insertion plate portion to one side and connected to the supporting part; and
a first guide stopper portion formed on the guide plate portion and protruding to a front side of the guide plate portion to restrict release of the brake pad.

10. The pad liner for a braking apparatus of claim 9, wherein the guide part further comprises:
a second guide stopper portion extending to be bent to the torque member side from the opposite sides of the guide plate portion and brought into close contact with the torque member.
